(19) United States
(12) Patent Application Publication
(10) Pub. No.: US 2024/0310283 A1
(43) Pub. Date: Sep. 19, 2024

(54) SUPER-RESOLUTION LENS-FREE MICROSCOPY

(71) Applicant: Arizona Board of Regents on Behalf of the University of Arizona, Tucson, AZ (US)

(72) Inventors: Euan McLeod, Tucson, AZ (US); Maryam Baker, Tucson, AZ (US)

(73) Assignee: Arizona Board of Regents on Behalf of the University of Arizona, Tucson, AZ (US)

(21) Appl. No.: 18/577,433

(22) PCT Filed: Jul. 11, 2022
(86) PCT No.: PCT/US2022/036629

§ 371 Date: Jan. 8, 2024

Related U.S. Application Data
(60) Provisional application No. 63/221,316, filed on Jul. 13, 2021.

(51) Int. Cl. G01N 21/64; G02B 21/00

(52) U.S. Cl. CPC G01N 21/648; G01N 21/6458; G02B 21/0076; G02B 21/008

(57) ABSTRACT

To avoid the limitation imposed by the optical diffraction limit when using a conventional lens-free microscopy systems on spatial resolution to approximately one-half the wavelength of used light, a proposed implementation of a lens-less imaging system utilizes a randomly nanostructured mask (preferably with features of substantially equal sizes) positioned within the limits/extent of evanescent near field of the imaged object (and, preferably, at a non-zero separation distance from the object) to encode high spatial resolution information about the object that would normally be lost due to diffraction when a conventional lens-free imaging system is used

### CROSS-REFERENCE TO RELATED APPLICATIONS

This US Patent Application is a national phase of the International Patent Application PCT/US2022/036629 filed on Jul. 11, 2022 and now published as WO 2023/287677, which claims priority from and benefit of U.S. Provisional Patent Application No. 63/221,316 filed on Jul. 13, 2021. The disclosure of each of the above-identified patent documents is incorporated by reference herein.

### STATEMENT REGARDING FEDERALLY SPONSORED RESEARCH OR DEVELOPMENT

This invention was made with government support under Grant No. 1807590 awarded by National Science Foundation. The government has certain rights in the invention.

### RELATED ART

Lens-free microscopy (LFM) methodologies available up to-date rely on computational algorithms to reconstruct microscopic images from diffraction patterns recorded on an image sensor. Advantages of the LFM over conventional microscopy include higher space-bandwidth product (defined as a product of the field of view and the number of resolvable pixels) and more compact, cost-effective, and field-portable form factors. These attributes make LFM particularly well-suited for applications such as point-of-care medical histology and diagnostic tools, neuron imaging, cell migration studies, rapid characterization of manufactured materials, and distributed environmental sensing of air or water quality. Each of these applications demands high resolution for resolving sub-cellular details, synthesized nanoparticles, or nanoscale pollutants.

LFM has also been used in various imaging applications, including smear and breast cancer tissue diagnostics, incubator in situ cell proliferation studies, biomolecular sensing, microfluidic monitoring, high-energy particle detectors, aerosol sensing, water pollution monitoring, and characterization of synthesized nanomaterials.

Traditionally, LFM systems are limited in resolution by the pixel size of a sensor of the used optical imaging system. Diverse work has been done to surpass this limit through pixel super-resolution and synthetic aperture techniques. The current limit depends on a variety of factors, including signal-to-noise ratio (SNR), coherence, and diffraction, but the best demonstrated resolution for coherent imaging is λ/2.8 (where λ is the wavelength of utilized light). For incoherent imaging (e.g., fluorescence, substantially incoherent light), the best resolution is even lower: about λ/0.5.

### SUMMARY

Embodiments of the invention provide an optical system configured to font) an image of an object in light having a wavelength. Such optical system includes an optical imaging system which, in turn, includes a mask layer defined by nano-sized randomly distributed elements and, in operation, positioned in an evanescent near field of the object; and an optical detector, disposed substantially parallel to the mask layer at a distance beyond and/or outside of the evanescent near field of the object. The optical imaging system does not include a lens. In at least one implementation of the optical system, one or more of the following structural conditions may be satisfied: (a) the mask layer is defined by at least one of (ai) a metasurface containing nano-sized material particles randomly distributed across an optical substrate; (aft) a material layer having nano-sized openings formed therethrough and distributed randomly across such material layer; and (aiii) a layer of optical material having non-uniform spatial distribution of a refractive index; (b) when the mask layer is defined by nano-sized elements that are randomly distributed across the optical substrate, the optical substrate is separated from the optical detector by the mask layer; (c) when the mask layer is defined by the nano-sized elements that are randomly distributed across the optical substrate, the optical substrate has a thickness that is smaller than the wavelength of light used for imaging; (d) when the mask layer is defined by the nano-sized elements that are randomly distributed across the optical substrate, the optical substrate carries, during the process of imaging, the object on a surface of the substrate. In substantially every embodiment, the optical system may be configured to satisfy one or more of the following conditions: (1) the optical system includes one or more of a source of light configured to generate light and an optical illumination system configured to deliver such light to the mask layer; and (2) the optical detector is disposed to directly face the mask layer without an optical component therebetween. Embodiments of the invention additionally provide an article of manufacture that incorporates an embodiment of the optical imaging system and/or at least a portion of the optical system, as identified above (for example, an optical substrate having a thickness value smaller than a depth of evanescent optical field produced by an object irradiated with light a predefined wavelength, and a mask layer defined by nano-sized elements randomly distributed on a surface of the substrate).

Embodiments of the invention additionally provide a method for using the embodiment of the optical system identified above. While utilizing an embodiment of the optical system, the method includes the step of intersecting evanescent optical fields that emanates from an object irradiated with an incident optical wavefront (such wavefront contains light at an optical wavelength) with an optical imaging system that does not contain a lens element and that includes a mask layer not only defined by nano-sized randomly distributed elements but also necessarily positioned in an evanescent near field of the object. The method additionally includes the step of receiving, at an optical detector disposed beyond and/or outside the evanescent near field of the object with respect to the mask layer, the light from said incident optical wavefront that has interacted with the object and with the mask layer and that necessarily contains spatial frequencies representing the evanescent optical field, thereby forming an optical data set representing and reproduced as an encoded image of the object. The method additionally includes a step of transforming—with the use of programmable electronic circuitry the encoded image of the object into a resolved image of the object, wherein a smallest spatially-resolved elements of the resolved image has extent smaller than half of the optical wavelength. In a related case of incoherent illumination, the achieved resolution is equal to or better than five times the optical wavelength. Additionally or in the alternatively—and substantially in every embodiment, the method may be configured to satisfy at least one of the following conditions: (a) the mask layer is carried and/or supported by an optical substrate and is separated from the object by the optical substrate, and (b) a spatial resolution of the resolved image is necessarily higher than that defined by an optical diffraction limit (that is, smaller features can be resolved than that allowed to be resolved according to the optical diffraction limit concept). Furthermore, substantially every implementation of the method may be configured such that the step of intersecting includes interacting the light from the incident optical wavefront with the mask layer only after such light has interacted with the object; or the intersecting includes interacting the light from the incident optical wavefront with the object after such light has interacted with the mask layer. Additionally or in the alternative, and in at least one implementation of the method the step of intersecting the evanescent optical field may include intersecting the evanescent optical field with one of: (1) a metasurface containing nano-sized material particles randomly distributed across the optical substrate; (2) a coating layer having one or more of (i) nano-sized openings therethrough and distributed randomly across the coating layer, and (ii) nano-sized elements of a coating material of the coating layer; (3) a material layer having a non-uniform spatial distribution of a refractive index. In one or more embodiments, the method may be configured such that the object includes a fluorophore, the mask layer is configured as an amplitude mask, and the method additionally includes the steps of exciting the object with a pulse of incident light at a first moment of time, and exposing the optical detector to light from the pulse of incident light that has interacted with the object and the amplitude mask at a second moment of time delayed from the first moment of time by at least a portion of duration of the pulse and/or where the step of receiving includes transmitting the light from the incident optical wavefront from the mask layer to the optical detector in absence of an optical spectral filter between the mask layer and the optical detector. Optionally, the optical spectral filter may be present in front of both the object being imaged and the mask layer (such that the optical spectral filter interacts with incident light prior to interaction of light with the object and/or the mask layer). In one specific version of the latter embodiment, the step of receiving may include receiving, at the optical detector, an optical shadow cast thereon by a combination including only the object, the mask layer, and the optical substrate. Additionally or in the alternative, substantially every embodiment of the method may be configured to satisfy one of the following conditions: (i) the step of transforming the encoded image includes minimizing a cost-function that at least partially represents differences between first and second encoded images of the object (here, the first encoded image represents the object in an initial position and the second encoded image represent the object that has been repositioned from the initial position); (ii) the step of transforming includes defining an inverse Fourier transform of a first function representing a convolution of a decoding function with a second function (here, the second function represents a spatial distribution, of the light at the optical detector, which distribution has been modified according to a distance separating the mask layer from the optical detector; and (iii) the step of transforming includes utilizing a convolutional neural network. Illumination of the object may be performed-in at least one case-with a substantially planar optical wavefront.

### BRIEF DESCRIPTION OF THE DRAWINGS

The idea and scope of the invention will be more fully understood by referring to the following Detailed Description of Specific Embodiments in conjunction with the Drawings, of which:

FIGS. 1A, 1B, 1C, and 1D provide an overview of an experimental approach configured according to the idea of the invention. FIG. 1A: a schematic representation of an embodiment of an imaging apparatus showing the optical system that includes an optical imaging sub-system devoid of an optical lens. FIG. 1B: Frequency-domain representation of an object, composed of propagating spatial frequencies and evanescent spatial frequencies with |kₓ|>2πn/λ. In conventional imaging systems, the loss of information contained at evanescent frequencies limits the resolution. FIG. 1C: A representation of a nanostructured surface in frequency domain. FIG. 1D: Frequency domain representation of light exiting the nanostructured surface. The upper line represents the total field, while the lower line is the field calculated by neglecting the object's evanescent frequencies. The difference between these lines indicates that the mask has encoded evanescent features of the object into light that now can propagate towards the image sensor.

FIGS. 2A, 2B, 2C illustrate resolution of incoherent 2-point imaging. FIG. 2A: Comparison of root-mean-squared error (RMSE) between the pattern generated on the image sensor by a single point source of light on the optical axis with that generated by two sources of light separated by different distances. Using a nanostructured mask (upper line I), it is possible to achieve resolution of about 20 nm, whereas without such mask (lower line II), the resolution limit is 3 μm. FIGS. 2B, 2C illustrate simulated patterns recorded on the image sensor for two different spacings (40 nm and 30 μm) between the two point sources of light (referred to in the Figures as a dipole spacing). As in FIG. 2A, lines I and II correspond to the patterns simulated with and without a mask, respectively. Fat, lightly shaded lines correspond to 40 nm spacing in FIG. 2B and 30 μm spacing in FIG. 2C, while narrow dark lines correspond to an average of 30 noisy simulations with zero spacing, which is provided as a reference. The inset in FIG. 2C shows how the peak in the pattern recorded without a mask is starting to broaden due to the separation of the two point sources.

FIGS. 3A, 3B, 3C, 3D, 3E, 3F, 3G, 3H illustrate methodology for simulating scalar fields. The series of panels show how the imaged pattern (generated by two incoherent point sources) is simulated. All plots represent normalized light intensity (magnitude-squared field).

FIG. 4 represents low-light performance of the embodiment of FIG. 1A. In this simulation, only 10⁴ photons were assumed to reach a single row of pixels on the image sensor. Curve I—with nanostructured mask; curve II—without such mask. Compare to the low-noise case in FIGS. 2A, 2B, 2C.

FIGS. 5A, 5B, 5C provide a comparison between the proposed coupled dipole method (CDM) and conventional finite difference time-domain (FDTD) approaches. FIG. 5A: a 3D structure of 100 Au (gold) nanoparticles each with a diameter of 40 nm. FIG. 5B illustrates the intensity of light I_{z} at a point on the z-axis 0.8 μm above the structure normalized by incident intensity of light I_{inc} incident onto the structure as a function of number N of particles in the 3D structure. The incident light has a wavelength of 1550 nm. For the “Fast” FDTD simulation, the accuracy of the simulation diverges significantly from that of the CDM and “Slow” FDTD simulations. The inset of FIG. 5B shows the magnitude of the electric field at a plane located at 0.8 μm above the 3D structure of nanoparticles. FIG. 5C addresses the simulation time. The simulation with the use of CDM is more than ˜3 orders of magnitude faster than the simulation with the “Fast” FDTD method.

FIGS. 6A, 6B, 6C, 6D present simulated object reconstruction via particle swarm optimization (PSO). FIG. 6A: The cost function quantifies the error in captured image sensor patterns between simulated point sources at various separations and a pair of point sources separated by λ/10=50 nm, which is considered the ground truth for this simulation. A 2D Au nanoparticle mask with 10% fill fraction is assumed (other parameters are the same as those listed in Table 1). The particle swarm optimization approach finds the global minimum, as indicated by a cross at about d=49.8 nm, near the bottom of the plot of the cost function. FIGS. 6B, 6C, 6D: Examples of simulated image sensor patterns for different separations between point sources of light.

FIG. 7A presents an image of a TEM window with 300 nm spherical fluorescing europium chelate particles on the top side of the window and the mask layer defined by 100 nm gold spherical nanoparticles on the back side.

FIGS. 7B, 7C provide images demonstrating experimental ability and practicality to configure an embodiment of the invention and, in particular, to randomly distribute 100 nm gold nanoparticles on the back side of the TEM window of FIG. 7A. FIG. 7B: a TEM image of 100 nm gold nanoparticles randomly distributed on the back side of the TEM window. FIG. 7C: a zoomed-in version of image of FIG. 7B with distances between particle aggregations measured and indicated to demonstrate the ability to create gaps in the nanoparticle mask on the order of the size of the gold nanoparticles.

FIGS. 8A, 8B: demonstration of encoding of fluorescing objects (europium chelate particles) with the mask layer defined by spatially randomly distributed 100 nm sized spherical gold nanoparticles. FIG. 8A: A lens-free image of a sample of 300 nm fluorescing europium chelate spherical nanoparticles deposited on the top side (farthest from the sensor) of a TEM window; see FIG. 7A. FIG. 8B: A lens-free image, acquired with an embodiment of the optical system of the invention, of the sample of FIG. 8A with an embodiment of the optical imaging system of the invention including the mask layer defined by 100 nm gold spherical nanoparticles deposited on the bottom side (closest to the sensor) of the TEM window; see FIG. 7A.

FIG. 9 provides evidence that the fluorescing sample/object imaged in FIGS. 8A, 8B is masked by the gold nanoparticles forming the mask layer. Specifically, FIG. 9 is a TEM image of the sample of 300 nm fluorescing europium chelate spherical nanoparticles on top-side of the TEM window with 100 nm gold spherical nanoparticles on the back-side of the TEM window. The 100 nm gold nanoparticles of the mask layer, encircled in the image for ease of identification, can be seen in-between the 300 nm nanoparticles of the object.

FIG. 10 presents the spectra of key components of the system as well as an image of a europium chelate nanoparticles (NPs). The inset is an experimentally acquired time-gated fluorescence image of Eu NPs dispersed on a substrate without any near-field mask present. The spectra, presented by various curves, have all been normalized and are provided by the corresponding manufacturers (High-Speed Photo-Systeme, Bangs Labs, and FLIR).

Generally, the sizes and relative scales of elements in Drawings may be set to be different from actual ones to appropriately facilitate simplicity, clarity, and understanding of the Drawings. For the same reason, not all elements present in one Drawing may necessarily be shown in another.

### DETAILED DESCRIPTION

The unsatisfied need in availability of a microscopy-based imaging methodology that is characterized by both cost-efficiency and high space-bandwidth product to allow simultaneous imaging and resolution of multiple objects within a large field of view is solved by contriving an optical imaging system which (a) is devoid of such an optical element that, in operation, transfers light between mutually optically-conjugated surfaces, and in which (b) light incident on a target object is filtered through a mask that is formed as and defined by a layer of spatially randomly distributed nano-sized mask features (for example, nano-sized features randomly distributed on a supporting substrate) while such layer is necessarily spatially separated from the object by a distance shorter than a wavelength of incident light used for imaging. The nano-sized features of the mask are configured to interact (and do interact during the imaging process) with the evanescent optical field representing object features at spatial frequencies that would have been necessarily attenuated and substantially lost during the process of conventional microscopic imaging. By so interacting with the evanescent field, the mask encodes the evanescent field into light propagating without attenuation to be included into an image of the object registered by an optical detector. (The detector may be disposed in the far field behind the mask).

While imaging with nanostructured masks has previously been attempted in combination with the lens-free microscopy, the best achieved spatial resolution of which a skilled person is aware was only 2 μm. Furthermore, the mask fabrication process previously utilized in related art involved focused ion beam milling, which is time consuming and expensive. Moreover, the functional layer of the so-fabricated metallic mask—that is, the nano-structured metallic layer—was necessarily configured to be in direct physical contact with the sample or object being imaged which—as is well recognized by a skilled person—could and very likely does perturb or alter the sample during the imaging process. (For example, studies of cellular adhesion and motility are sensitive to surface heterogeneity, as is the biomolecular functionalization of surfaces for capturing targets in biosensors.) Additionally, in demonstrations available up to-date, the calibration procedure necessarily involved raster scanning of a focused laser beam across the sample and measuring the far-field pattern (which, post-factum, can explain why the achieved resolution was not better than the diffraction limit, as the focused beam is itself diffraction limited, polarized, and extended in the z-direction and is therefore not a good surrogate for a true unpolarized incoherent point source).

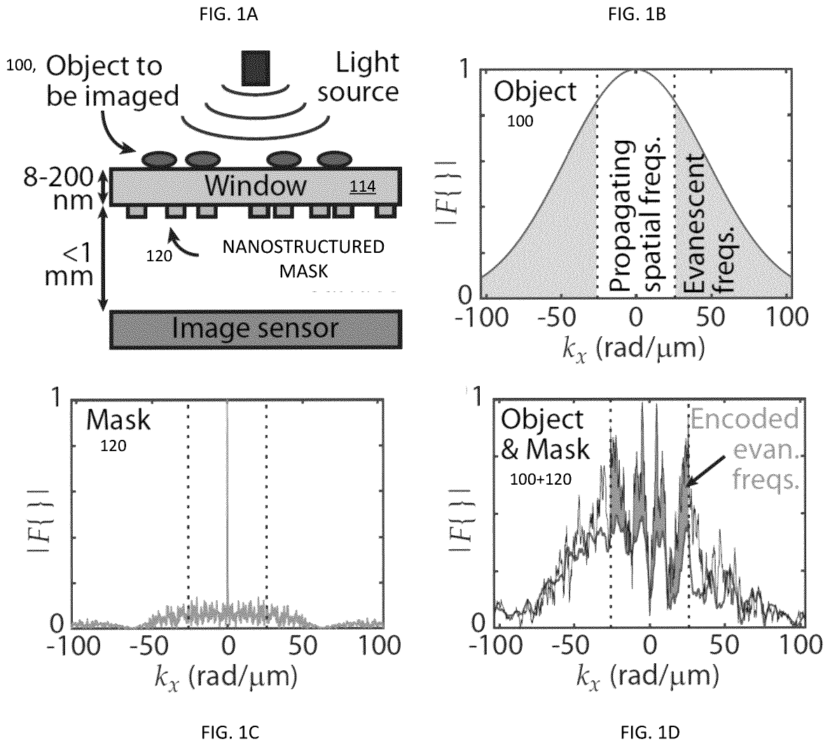

According to an idea of the present invention, in order to effectuate image reconstruction with spatial resolution significantly exceeding the conventional optical diffraction limit in both fluorescent and coherent light employing modalities, an embodiment of the experimental optical system similar to that schematically illustrated in FIG. 1A may be used. Here, the lens-free combination of optical elements including the mask layer and the optical detector forms an optical imaging (sub-) system of the overall optical system. To define the embodiment of the overall optical system, the optical imaging system is complemented with an optical illumination (sub-) system that includes at least a source of light (illustrated in FIG. 1A).

In operation, the object to be imaged is generally placed to be spatially separated from an embodiment of the mask of the invention by a distance shorter than an extent of the near optical field produced by such object when the object is irradiated with light. In one specific case, however, the object 100 may be placed on one side of an ultrathin (in the example shown—between 8 nm and 200 nm) optically transparent window or substrate 114. On the other side of the window, a spatially-random plurality or array of (in this example, metallic) nanoparticles is created, thereby forming a nanostructured mask layer 120 (or, interchangeably, a mask, for short). This nanostructured mask possesses (is characterized by) high spatial frequencies in the Fourier domain (FIG. 1C). The diffraction of light arriving from the object through the mask and onto the image sensor can be approximated as a frequency domain convolution between the object 100 and the mask 120. Because the mask layer is positioned within the evanescent near-field of the object, this convolution operation effectively “sweeps” or encodes at least some of the high spatial frequencies characterizing the object 100 (FIG. 1B) that were initially beyond the diffraction limit into lower spatial frequencies that now freely propagate to the image sensor (FIG. 1D). According to the idea of the invention, after recording the so-formed diffraction pattern on the image sensor, the recorded encoded image is computationally decoded and reconstructed/transformed into a super-resolved image of the object 110. It is appreciated that, in practice, the order in which the mutual orientation(s) and positioning of some of the sub-components of the embodiment of the apparatus presented in FIG. 1A may be changed. For example, in one implementation, the orientation of the window or substrate may be flipped such that light from the light source initially strikes the nanostructure surface, then propagates through the window, and the interacts with the object to be imaged.

For initial tests, the complimentary metal-oxide-semiconductor (CMOS) image sensor model CM3-U3-31S4M-CS (see Table 1) was used. The protective cover glass was removed from the sensor, which enabled the sample-to-sensor distance (z₂) to be on the order of a few hundred microns, rather than millimeters. A small value of z₂ led to a brighter signal on the image sensor, which could effectively reduce noise and thereby indirectly enhance resolution (see follow-up discussion in reference to FIGS. 1A-2C and 4). To measure the effect of noise on resolution, a camera model with ˜3× higher noise levels, but otherwise similar specifications, could be tested.

In further reference to FIG. 1A, in at least one case, the nanostructured mask 120 and the sample/object 100 were attached to opposite sides of a silicon nitride (Si₃N₄) window/substrate (commercially available for use in transmission electron microscopes, TEMs) with thicknesses ranging from 8 nm to 200 nm, with area on the order of 1 mm². Such TEM window is recessed a few hundred microns into a Si wafer on one side, to form a small gap between the window and the active area of the image sensor. On the bottom side of the window, the mask was fabricated out of randomly positioned metallic nanoparticles drop-cast from a liquid suspension. (In a related implementation, in order to image larger samples with greater throughput, a large area (up to 40 mm²) Si₃N₄ window on a larger Si wafer support may be fabricated. Such large windows can make use of the full image sensor active area. This may be accomplished by procuring a wafer with a desired thickness of silicon nitride and then etching through the silicon support from the back using potassium hydroxide, which etches silicon but not silicon nitride. If large area windows are too fragile and/or flexible, the window can be constructed from multiple “panes” with narrow silicon frames between them.)

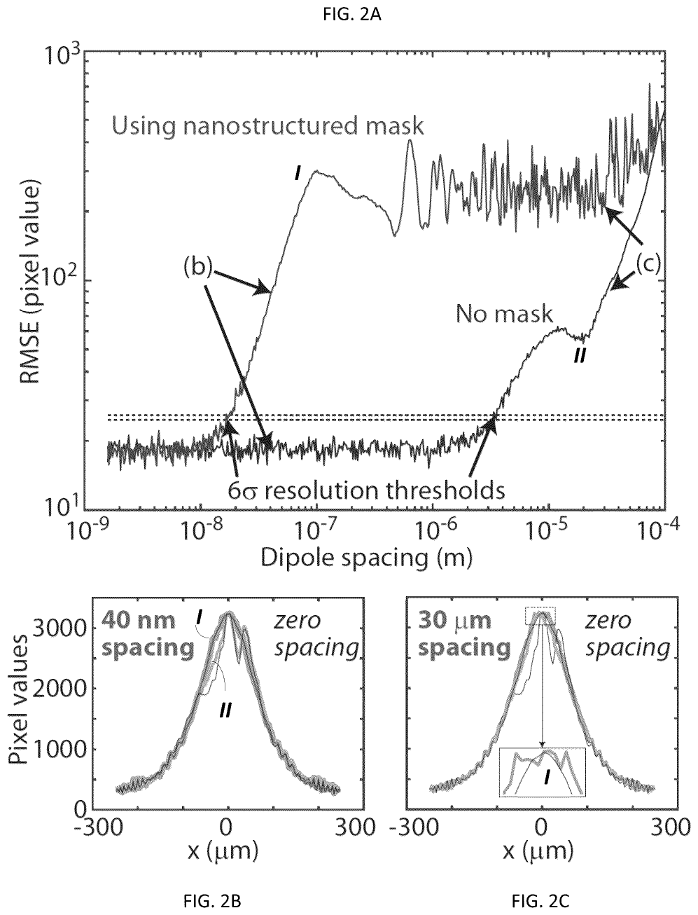

TABLE 1
Parameters used in the simulations in FIGS. 2A-2C & 3A-3H.

| System parameters | | | Image sensor parameters | | |
|---|---|---|---|---|---|
| Free-space wavelength (λ) | 500 | nm | Pixel size | 3.45 | μm |
| Spacing between sources (Δx) | λ/10 | | Bit depth | 12-bit | |
| Window thickness (δz) | 50 | nm | Quantum efficiency | 71% | |
| Window (Si₃N₄) refractive index (n_{window}) | 2.0652; 53 | | Pixel well depth | 9777 | electrons |
| Diameter (width) of particles in random mask | 60 | nm | Read noise | 2.89 | electrons |
| Fill fraction of mask | 30% | | Electrons per bit | 2.72 | electrons |
| Distance from mask to image sensor (z₂) | 100 | μm | ADC gain range | 0-48 | dB |

To demonstrate the feasibility and operability of the idea of the invention, initially a scalar field with a binary amplitude mask was assumed, and then the situation was generalized to include vector fields and more realistic mask models.

(A) Scalar Field Analysis. To assess the spatial resolution achievable with the use of the idea of the invention, the lateral distance between two incoherent point sources was varied starting from zero, and the simulated pattern on the image sensor is monitored. When the pattern was significantly different (as determined by the noise statistics, see Noise Analysis section below) from that correspond to the starting zero-separation case, the two point sources were considered to be resolved.

The results of this analysis are shown in FIG. 2A, where the use of a nanostructured mask enabled ˜30 nm resolution (˜λ/25), whereas without a mask, the achieved spatial resolution was ˜3 μm, which was primarily determined by the object-to-sensor distance. Since there was no lens in the imaging system and the two point sources were chosen to be incoherent, the achieved spatial resolution was quite poor in this reference case without a mask.

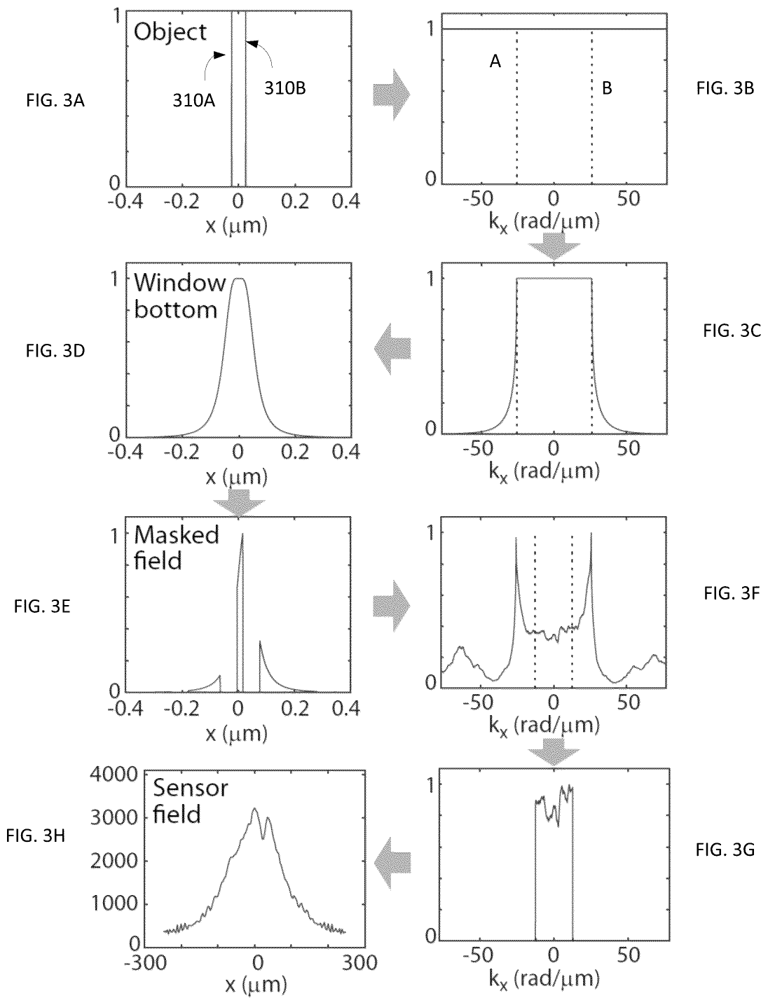

These simulated objects and masks exhibited spatial features in the x-direction, but were uniform in the y-direction. Key parameters are summarized in Table 1, and a graphical description of the simulation process is addressed in FIGS. 3A, 3B, 3C, 3D, 3E, 3F, 3G, and 3H.

In FIG. 3A, two delta-function represented point-sources 310A, 310B are shown to be separated by λ/10, illustrating and corresponding to a case where the spacing between features of the object is below the conventional diffraction limit, but still resolvable using a nanostructured mask according to the methodology of the present invention. The Fourier transforms of these point sources are separately analytically computed and the superposition of their intensities is plotted in FIG. 3B. Because the sources are delta-functions, the amplitude of light produced by these sources is substantially constant across all spatial frequencies. These point sources exhibit propagating spatial frequencies (that is, frequencies present between the two dashed lines A and B, where |kₓ|>2πn_{window}/λ) as well as evanescent spatial frequencies (which lie outside the dashed lines A, B). The optical fields E from the two point sources are separately propagated through the window 114 using the angular spectrum method according to

$$ℱ \{ E ( x , y , z ) \} ℱ \{ E ( x , y , 0 \} exp ( iz \sqrt{{k}^{2} - {k}_{X}^{2} - {k}_{Y}^{2}} ) \qquad ( 1 )$$

where F{ } represents the Fourier transform in the x and y dimensions, and k=2πn/λ. The angular spectrum method of propagation makes no assumptions on the scale of z, and is accurate even over nanoscale, subwavelength dimensions for either scalar or vector fields. Outside the dashed vertical lines A, B in FIGS. 3A-3H, the term contained inside the square root in (Eq. 1) becomes negative, thereby causing those evanescent frequencies to be attenuated due to propagation through the window. However, as the skilled artisan will now readily appreciate, because of the purposeful and intentional choice of the thickness of the window/substrate employed in the embodiment of the invention to be a nanoscale thickness, the optical field at these evanescent frequencies is only partially attenuated as shown in FIG. 3C. (For evanescent frequencies, the field amplitude has the form of a real decaying exponential, exp(−z k_{z}), which is a simplified form of the exponential term in Eq. (1). Typically, k_{z} is on the order of M. So, if z>>wavelength, then exp(−z k_{z}) is infinitesimally small and can be approximated by zero. On the other hand, if z<λ, as would be the case for a nanoscale window thickness as employed in an embodiment of the invention, then the term exp(−z k_{z}) is smaller than one but not infinitesimally small, and, therefore, this term serves to partially attenuate the electric/optical field without completely extinguishing it.)

In FIG. 3D, the fields from the two point sources 310A, 310B are shown to be brought back to the spatial domain through the appropriate separate inverse Fourier transforms.

In at least one implementation, the nanostructured mask 114 may be modeled as an opaque, amplitude mask that is configured to block the light in random locations corresponding to positioning of the spatially-randomly distributed features with 60 nm size each. This multiplication of the fields by the masking function in the spatial domain corresponds to a convolution in the frequency domain, enabling the mask to effectively sweep some previously-evanescent information into lower propagating frequencies, where it is encoded. The masked fields from the two sources are brought back to the frequency domain through Fourier transforms (FIG. 3F) and then propagated to the image sensor (FIG. 3G), again with the use of (Eq. 1). Because in this case the optical field propagation was considered to occur through air rather than the window material, the evanescent cutoff (indicated by the dashed vertical lines) occurred at lower spatial frequencies. Furthermore, due to the longer propagation distance, the evanescent frequencies were effectively completely attenuated. Inverse Fourier transforms of the fields from the two sources 310A, 310B brought the result back to the spatial domain, thereby providing a simulation of the pattern that would be recorded by an image sensor (FIG. 3H). At this step, we took into account the image sensor parameters and noise characteristics (as discussed in more detail in the next section).

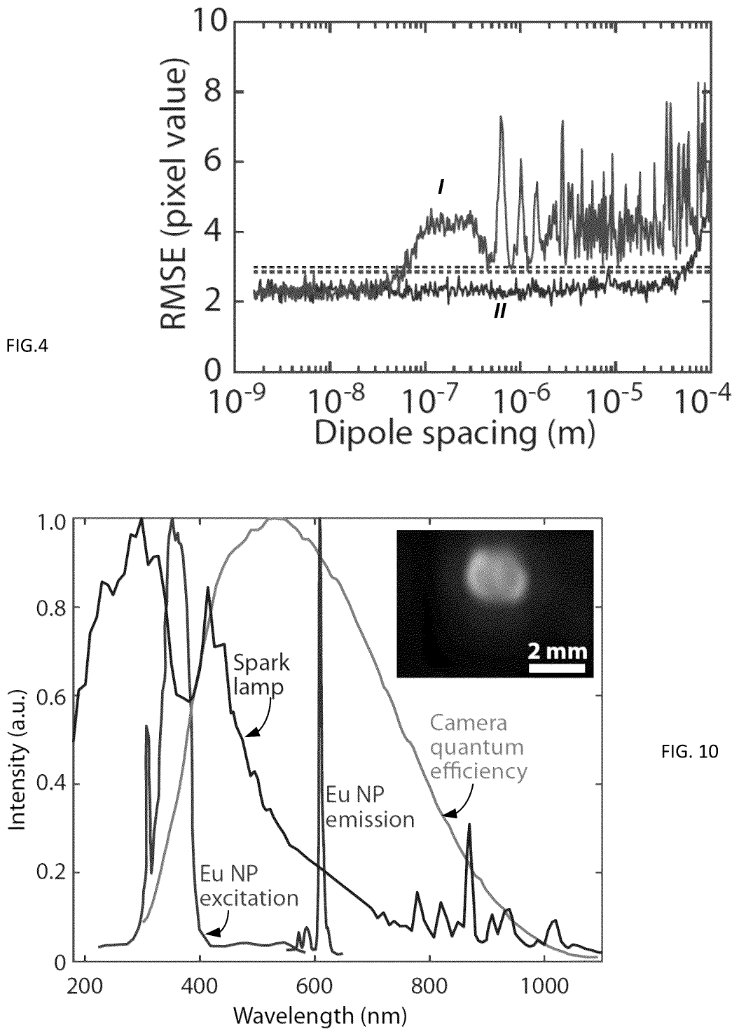

Noise analysis. In at least one embodiment, the CM3-U3-31S4M-CS image sensor can be used, which is commercially available from FLIR. Before adding any noise in the simulations, the simulated data (originally at a pitch of 0.625 nm) was resampled according to the pixel pitch of the used image sensor. According to the specifications of the CM3-U3-31S4M-CS, the pixels of such image sensor saturate after collecting 9777 electrons, which corresponds to 13770 photons per pixel based on its quantum efficiency of 71%. Accordingly, the present simulations were scaled such that number of photons incident on the brightest pixel was set at 90% of the saturation capacity (FIGS. 2A-2C and 3A-3H) or where the total number of collected photons across the whole image was specified (FIG. 4). This second implementation may be particularly important when considering sources such as single fluorescent molecules that can photobleach after emitting a limited number of photons.

After representing the image in terms of photons per pixel, shot noise was added by randomly drawing new pixel values from Poisson distributions with means specified by the initial, noise-free pixel values. These values were converted to numbers of electrons per pixel based on the sensor quantum efficiency, and temporal dark (read) noise was also added by drawing noise values from a Poisson distribution with mean equal to the sensor specification of 2.89 electrons. Pixel values were then capped at 9777 electrons, gain (if any) was applied, and pixel values were digitized by dividing by the specified electrons per bit value, rounding to the nearest integer, and finally capping at 2¹² according to the sensor bit depth.

When it was assumed that only 10⁴ photons were collected by the image sensor, then the results presented in FIG. 4 could be obtained. The results of FIG. 4 evidence that, with a spatial resolution of ˜60 nm, the nanostructured mask 120 still performed better in imaging the chosen object than the absence of any mask, which has a resolution of ˜50 μm (however the obtained spatial resolutions were worse than those of the higher light case in FIGS. 2A-2C). Notably, so far the proposed analysis was applied to 1D simulations, while a full 2D imaging situation provides more information that could lead to better resolution. With more expensive sensors such as electron-multiplied CCD cameras, the low-light performance could be further improved. The cost of the initially selected image sensor (including the USB board used) was under 500 USD.

(B) Vector Forward Analysis. The model of the mask 120 as an infinitesimally-thin binary amplitude mask may not be necessarily very accurate, and the errors caused by this assumption may affect the image sensor patterns. A more accurate model of the system can be based on decomposing the mask into individual mask particles (which corresponds to a method for actually fabricating such a mask). This model is based on the coupled dipole method (CDM, see for example B. T. Draine and P. J. Flatau, “Discrete-Dipole Approximation For Scattering Calculations,” Journal of the Optical Society of America A 11 (4), 1491 (1994); osapublishing.org/abstract.cfm?URI=josaa-11-4-1491; the disclosure of which is incorporated herein by reference), where each deeply subwavelength particle in the nanostructured mask is approximated as a dipole scatterer.

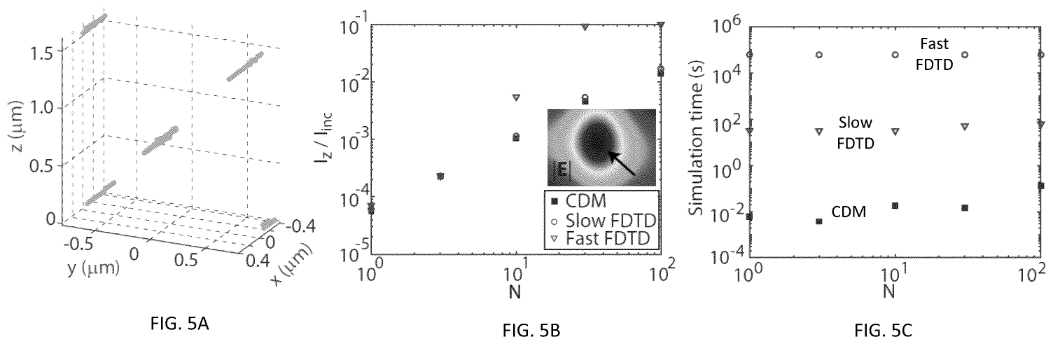

Notably, the use of the proposed approach to simulate the nanoscale light propagation is several orders of magnitude faster than conventional approaches such as finite difference time-domain (FDTD). The results of the example simulations shown in FIGS. 5A, 5B, 5C are those of simulating a 3D structure designed for maximal side-scattering (rather than the 2D masks the embodiments of which were discussed above), however, the general scaling in terms of speed and accuracy would be similar. Both the CDM and FDTD simulations were run on a 2.60 GHz Intel Xeon E5-2660 with 256 GB of RAM. The CDM routine was programmed in MATLAB, and Lumerical's commercial FDTD Solutions software with a total field/scattered field (TFSF) method was used for the FDTD simulations. The results of two different FDTD simulation settings are shown in FIGS. 5A, 5B, 5C: (1) an accurate but slow simulation where the grid spacings are 2.2 nm; and (2) a fast simulation where the grid spacings are 20 nm. Even at the fast setting, the FDTD simulations are still ˜3 orders of magnitude slower than our CDM. This is because CDM simulation times scale with the number of particles rather than the total domain volume, which need not be completely filled. Despite their slow speed, we also still use commercial FDTD software simulations for validation.

### (C) Reconstruction/Transformation of the Encoded Image of the Object.

(C1) Optimization-based reconstruction The preliminary results shown in FIGS. 2A-2C indicate that the pattern recorded on the image sensor can identify the presence of two sources as opposed to a single source, provided that the sources are separated by a certain distance (in one specific case, by more than 20 nm). It begs an additional question: given that we can identify two sources, how accurately can their separation be measured? The answer to this question can be defined with the use of 2D simulations based on the CDM. In these simulations, the particle separation distance d is treated as an unknown variable in an optimization problem:

$$\hat{d} = arg max ‖ f ( d ) - y ‖ \qquad ( 2 )$$

where f(d) is the forward model similar to that in FIGS. 3A-3H, and y is the vector of all experimentally measured image sensor pixel values, similar to that shown in FIG. 3H. Notably, f(d) is a nonlinear function due to the complex-magnitude operation involved in measuring light intensity, and so it cannot be represented as a matrix multiplication.

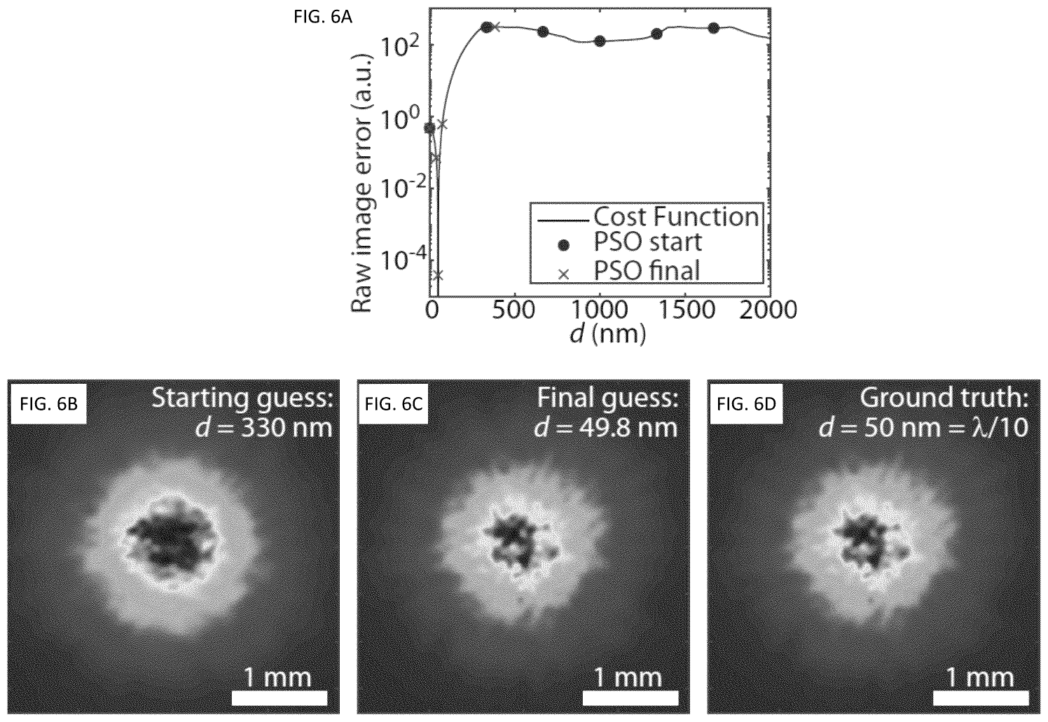

This type of optimization problem is non-convex and suffers from the presence of multiple local minima (see solid curve in FIG. 6A) due to interference fringe-like effects. To improve the ability to find the global minimum, a particle swarm optimization approach of B. T. Draine and P. J. Flatau, “Discrete-Dipole Approximation For Scattering Calculations,” Journal of the Optical Society of America A 11 (4), 1491 (1994); osapublishing.org/abstract.cfm?URI=josaa-11-4-1491; incorporated herein by reference) was implemented. In particle swarm optimization, the concept of a particle refers to a particular estimate of d, and not a physical particle. Multiple starting guesses for d were generated (solid circles in FIG. 6A), and then iteratively updated according to a mix of their local gradient (which would find the nearest local minimum) together with the best result found by the whole swarm of “particles.” This enabled the swarm to converge on a global minimum (crosses in FIG. 6A). These results showed that spatial resolution of the two point sources separated at λ/10 was possible with the implementation of the idea of the invention.

In a related embodiment, another optimization-based approach may be evaluated, according to which d is formulated as a longer array in which each element corresponds to a particular x-y coordinate on the sample, with coordinate spacings<<λ/2. The values of the elements of d correspond to the amplitudes of the sources in the sample. In this way, a full super-resolved image of the sample is effectively reconstructed. For sparse samples, an additional regularization term on the right-hand side of Eq. 2, (+κ∥d∥ₗ₁) can be included, which is known to promote sparsity.

(C2) Characterization of resolving power based on Fisher information. A related way of characterizing the imaging system of FIG. 1 is with the use of the variance in the error of estimates of source separation distance. The Cramer-Rao statistical bound states that the variance of an unbiased estimator is at least as high as the inverse of the Fisher information. In current experiments, the Fisher information can be estimated by:

$$\hat{I} ( \hat{d} ) = - [ \frac{{\partial }^{2}}{d {\partial }^{2}} ln p ( y \vert d ] {( \frac{{\partial }^{2}}{d {\partial }^{2}} ln p ( y \vert d ) )}_{d = \hat{d}} \qquad ( 3 )$$

where p(y|d) is the joint probability density function for all the pixel values in the image y given a source separation of d. When there is more than one parameter in the reconstruction, then d→d, and the approach generalizes to the estimation of a Fisher information matrix.

According to the Cramer-Rao limit, the uncertainty in source separation is bounded by

$$σ ( d ) \geq 1 / \hat{I} ( d ) \qquad ( 4 )$$

Both the simulated and experimental results can be compared to this theoretical bound. Through multiple noisy trials, the joint probability distribution p(y|d) can be sampled, where the values of d are known either through the input to the simulation or through electron microscopy. Additionally or in the alternative, σ(d) by can be directly quantified by comparing the results of the performed reconstruction to the known true values of d. If σ(d) is close to the Cramer-Rao bound (Eq. 4), then it may be concluded that the resolution is primarily limited by the optical system and mask, whereas if

$$σ ( d ) ≫ 1 / {\hat{I} ( d )}^{- 1 / 2} \qquad ( 5 )$$

then one can conclude that the reconstruction process (as opposed to the optical system) is the limiting factor.

(C3) Direct Convolution-Based Decoding. Following at least some of the known work on coded aperture cameras, a decoding approach can further be tested that is based on convolving the raw captured image with a decoding function. The advantages of this approach are that it is noniterative and is physics based rather than training-data based, making it both very fast and well-suited for unknown types of objects. The challenge in this approach is that the standard coded aperture camera algorithms do not directly apply due to the mask being placed in the near-field of the object rather than in the pupil plane of an imaging system. Different concentrations and nanoparticle sizes in the mask may be tested to determine what set of masks works best with this approach.

In the case of coherent imaging, we can use the angular spectrum approach (Eq. 1) to model the electric field of the light at the sensor by,

$${\tilde{E}}_{sen} = [ \tilde{N} * ( {\tilde{E}}_{obj} exp ( {ik}_{z} ( {k}_{x} , {k}_{y} ) δ z ) ] exp ( {ik}_{z} ( {k}_{x} , {k}_{y} ) {z}_{2} \qquad ( 6 )$$

where a “tilda” symbol indicates a spatial Fourier transform of the field, N(x,y) is the function describing the transmission through the nanostructured mask, E_{obj} is the electric field generated by the object, δz is the thickness of the TEM window, z₂ is the distance from the window to the image sensor, and k_{z}=k²−kₓ²−k_{y}². Under the assumption that the nanostructured mask is highly random, it lacks any long range order, and its autocorrelation will approximate a delta-function. One can choose a decoding function \tilde{D}(kₓ,k_{y})=Ñ(kₓ,k_{y}), and then \tilde{D}*Ñ˜δ(kₓ,k_{y}). Finally, the reconstruction may be computed according to:

$${E}_{recon} = ℱ \{ exp ( - {ik}_{z} δ z [ \tilde{D} * ( {\tilde{E}}_{sen} exp ( - {ik}_{z} {z}_{2} ) ] \} \qquad ( 7 )$$

This equation is similar to that of Eq. 6 solved for E_{obj}, where the decoding function is used to effectively deconvolve the effect of the mask out of the electric field. Because of the finite width of \tilde{D}*Ñ and the loss of evanescent spatial frequencies in the back-propagation over the z₂ distance, a skilled artisan should not expect an exact equality between E_{recon} and E_{obj}.

For incoherent imaging, one can test similar approaches where field intensities are convolved with incoherent point spread functions rather than complex field amplitudes being convolved with coherent point spread functions, as was the case above.

(C4) Neural network/Deep-learning. Alternatively or in addition, and in at least one implementation of the methodology configured according to the idea of the invention, an image reconstruction process can be employed that utilizes using deep learning approaches based on convolutional neural networks. The difficulty in these types of approaches in image-based problems is that they typically require at least ˜10⁴ training images with a known ground-truth of the samples. In our case, we can divide a 1 mm² window area into 10×10 separate training images. The ground truth of both the mask and the sample can be obtained using two TEM images of the sample: one captured after mask deposition, but before sample deposition; and another captured after both the mask and sample have been deposited on the window. The mask ground truth and the captured image sensor patterns will be used as training inputs to the neural network. Images of 100 samples can then provide the desired 10⁴ training sets. The training and tuning of the neural network will be done using commercial packages such as TensorFlow or MATLAB's Deep Learning Toolbox. The performance of this reconstruction approach may be compared to the previous approaches in terms of accuracy and speed, considering both the training steps and sample image reconstruction after training is complete.

(D) Experimental lens-free time-gated fluorescence results. According to the noise analysis described in Section (A) above, it was expected that the imaging apparatus of FIG. 1A should be able to image a relatively small number of photons as might be expected from nanoscale emitters. To experimentally test this, an attempt to assemble a time-gated fluorescence system was undertaken. Whereas conventional fluorescence imaging systems rely on filters to reject excitation light and pass fluorescence emission, a time-gating system does not require spectral filters. In one implementation of the time-grated fluorescent system, the excitation pulse was provided by a spark lamp (HSPS Nanolite KL-K) that has a short pulse length (8 ns) with low jitter (±10 ns). The exposure of the image sensor was configured to start only after the excitation pulse was finished. When the fluorescence lifetime of the emitter was greater than the delay between the end of the excitation and start of the image sensor exposure, the fluorescence emission could not be captured.

The main advantage of implementing the time-gating imaging with the use of the proposed embodiment of the apparatus stems from the fact that there is no need for a spectral filter between the object and the image sensor and, therefore the object can be placed in close proximity to the image sensor, thereby increasing captured photon densities. While thin interference filters exist, making conventional fluorescence potentially viable here, the angle-dependent transmission of these filters would pose challenges for high-angle scattering from the nanostructured mask. (Alternatively, absorption filters are not angle dependent, but usually have to be quite thick to provide the high optical densities necessary for good contrast.)

The above-presented methodology of imaging, configured according to an embodiment of the invention, was utilized to image an object that included a plurality of europium chelate nanoparticles.

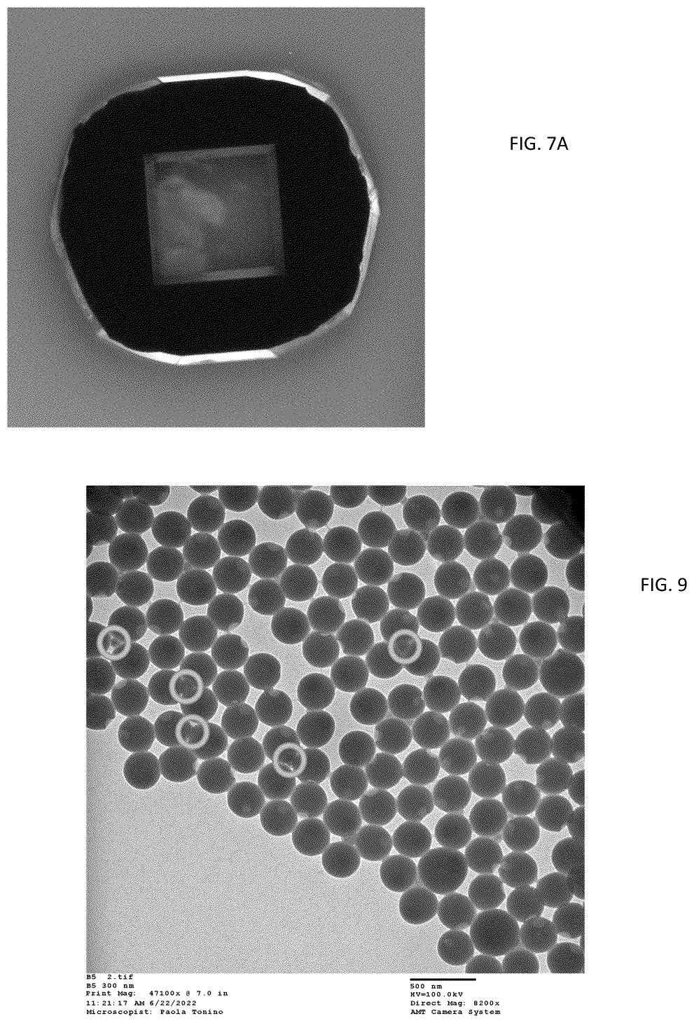

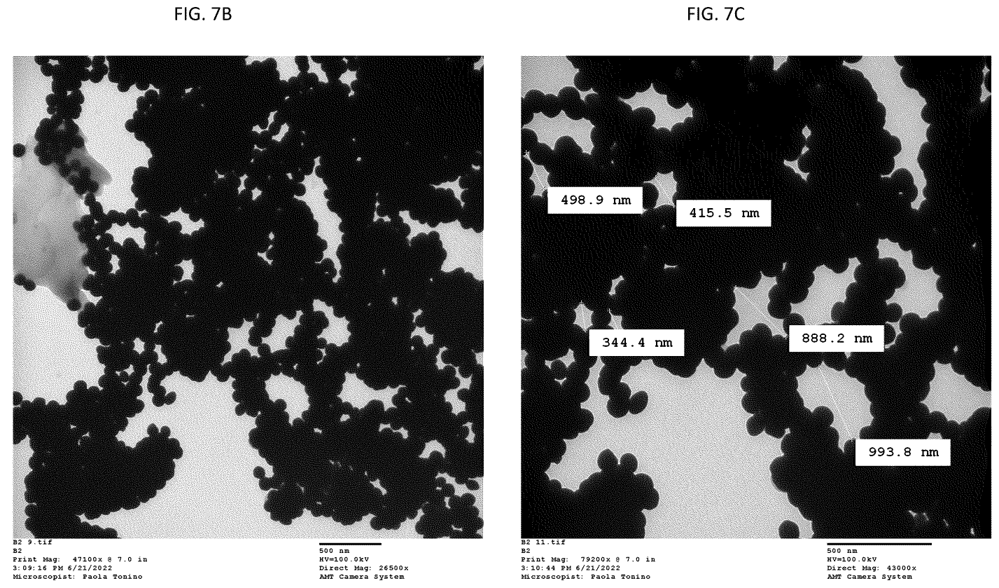

The europium chelate nanoparticles have a relatively long fluorescence lifetime (˜100 μs), which makes them easy to image in a time-gated setup. Europium chelate nanoparticles exhibit higher brightness, longer lifetimes, and greater stability than organic fluorophores, and, unlike quantum dots, their emission spectrum is not tied to their size. Thus larger nanoparticles could be used, which are brighter and can emit more photons. FIGS. 7A, 7B, 7C, 8A, 8B, 9, and 10 illustrate the results of such imaging.

FIG. 7A presents an image of a TEM window (optically transparent substrate, shown as 114 in FIG. 1A) with 300 nm spherical fluorescing europium chelate particles on the top side of the window and the mask layer defined by 100 nm gold spherical nanoparticles on the back side. FIGS. 7B, 7C provide images evidencing experimental ability and practicality to configure an embodiment of the invention and, in particular, to randomly distribute 100 nm gold nanoparticles on the back side of the TEM window of FIG. 7A. Here, FIG. 7B is a TEM image of 100 nm gold nanoparticles randomly distributed on the back side of the TEM window to form a mask layer (shown in FIG. 1A as 120). FIG. 7C presents a zoomed-in version of image of FIG. 7B with distances between particle aggregations measured and indicated to demonstrate the ability to create gaps in the nanoparticle mask on the order of the size of the gold nanoparticles.

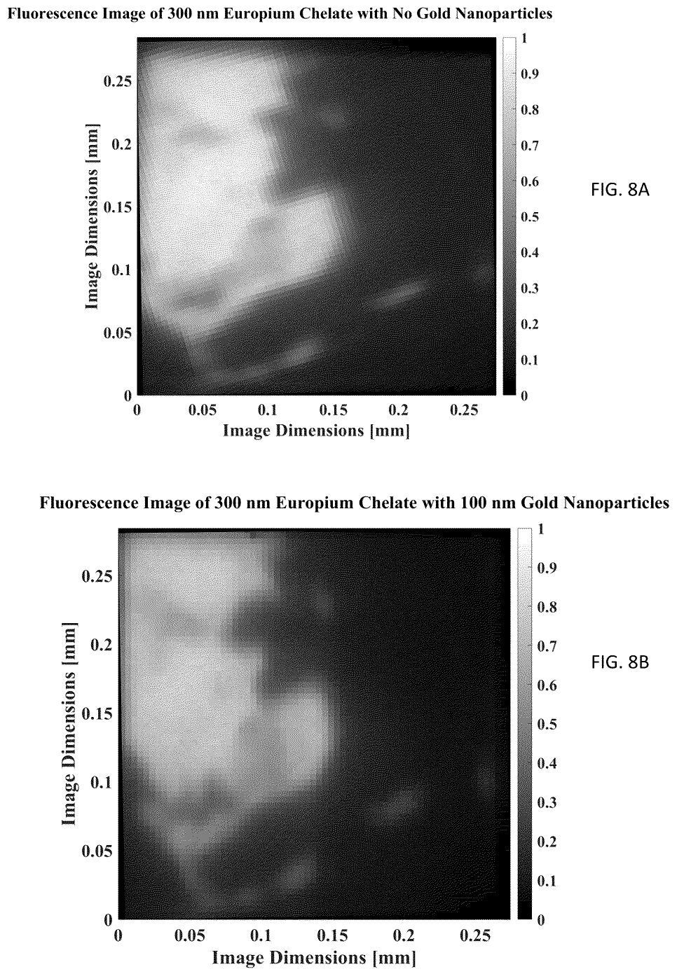

FIGS. 8A, 8B demonstrate the process of encoding of fluorescing objects (europium chelate particles) with the mask layer 120 defined by spatially randomly distributed 100 nm sized spherical gold nanoparticles. Here, a lens-free image of a sample of 300 nm fluorescing europium chelate spherical nanoparticles deposited on the top-side (farthest from the sensor) of a TEM window 120 is shown in FIG. 8A. FIG. 8B contains a lens-free image, acquired with an embodiment of the optical system of the invention.

FIG. 9 provides evidence that the fluorescing sample/object imaged in FIGS. 8A, 8B is masked by the gold nanoparticles forming the mask layer (such as layer 120). Specifically, FIG. 9 is a TEM image of the sample of 300 nm fluorescing europium chelate spherical nanoparticles on the top side of the TEM window with 100 nm gold spherical nanoparticles on the back side of the TEM window. The 100 nm gold nanoparticles of the mask layer, encircled in the image for ease of identification, can be seen in-between the 300 nm nanoparticles of the object.

FIG. 10 contains plots illustrating various spectra associated with the imaging process described above in reference to FIGS. 7A-7C, 8A-8B, and 9. The inset is an experimentally acquired time-gated fluorescence image of the object nanoparticles dispersed on a substrate without any near-field mask present. The spectra, presented by various curves, have all been normalized and are provided by the corresponding manufacturers (High-Speed Photo-Systeme, Bangs Labs, and FLIR).

The experimental results reflected in FIGS. 7A, 7B, 7C, 8A, 8B, 9, and 10 indicated that by tuning the camera parameters and time delays and averaging multiple images, detection of the emission from single nanoparticles with sufficiently high SNR was possible.

### (E) Additional Considerations

In different experiments, different particle sizes and concentrations may be tested prior to image acquisition procedure. In order to preserve the randomness of the distribution of nano-sized particles (of the mask) on the substrate, plasma-treating of the substrate surface can be employed to raise its surface energy, and/or using volatile organic solvents that dry quickly, and/or drying the sample in a vacuum oven, and/or spin-coating to rapidly thin the liquid suspension, and/or chemically-functionalizing surfaces to promote immediate bead attachment before the particles can self-assemble into regular arrays.

In at least one implementation, based on the images acquired with the optical detector of the proposed embodiment of the invention, 2D autocorrelations may be calculated to quantify the randomness of the spatial distribution of the mask-features at the mask and compare the different fabrication strategies discussed in the previous paragraph. The TEM images can be used to generate an accurate coupled dipole model of the experimental imaging system. To further enhance the accuracy, in at least one implementation ultra-uniform spherical gold nanoparticles (acquired commercially from Nanocomposix) with known substantially constant diameter and size coefficients of variation (CV)<5% can be used.

After mask characterization, the sample/object may be placed on the top side of the TEM windows. For incoherent imaging tasks, the sample/object may include dispersed nanoparticles such as europium chelates, fluorescent beads, quantum dots, and ultimately single molecules of fluorescent cyanine dyes; as discussed, for example, in Section (D). For coherent imaging experiments, an object/sample may include dispersed metallic and dielectric nanoparticles. Finally, for imaging complex objects, labeled cellular structures such as actin filaments labeled with rhodamine-phalloidin may be used.

To provide the excitation source for fluorescent samples, one can employ use a spark-lamp light source (High-Speed Photo-Systeme), as specified in Section (D). The spark lamp may be positioned as close as possible to the object so that a large portion of light hit the object. Alternatively, a high numerical aperture (NA) collecting lens (not shown in FIG. 1A) can be used to relay light from the source onto our sample. Alternatively or in addition, an excitation filter (e.g., the UV band pass filter) may be employed to restrict the spectrum of illumination (incident onto the object light) to a part of the spectrum where the image sensor is less sensitive.

For embodiments employing scattering of coherent light, a fiber-coupled supercontinuum laser with an acousto-optic tunable filter may be used to illuminate the object/sample at near-grazing incidence. This angle of incident of light may be chosen such that only scattered light reaches the image sensor. The use of a tunable supercontinuum light source would facilitate a process of quantification of the spatial resolution of the overall imaging procedure under illumination using different wavelengths. For holographic (interferometric) experiments, the same light source may be directed to the sample substantially at normal incidence. In the holographic experiments, the pattern imaged on the sensor will be the interference between the unperturbed illumination light, light scattered by the sample, and light scattered by the mask. In yet another implementation, the use of partially coherent light emitting diodes (LEDs) as light sources may be employed.

For all three types of illumination, in order to appropriately identify the source of and subtract out any background light, the experiments may be run without any window or sample in the system, with just a bare window, with a window and mask but no sample, and with a window and sample but no mask. Results of such additional measurement can be used as important control references.

In at least one implementation of the mask layer, estimation of geometry of unknown random masks may be performed with the use of TEM to measure the locations and sizes of all particles in the mask. These acquired data may be used to create an optical model based on the coupled dipole approach. Depending on their sizes, each particle may be represented by one or more dipoles. In order to test the accuracy of the model derived from the TEM images, the model predictions may be compared with to experimental measurements illuminating the mask with either (1) a single fluorescent nanoparticle fixed to the top side of the TEM window, (2) a focused laser beam, or (3) a fluorescent particle that is optically trapped in two dimensions against the window. The first approach facilitates the testing of the accuracy in a few locations of the mask with an object that is most similar to a true incoherent point source. In the latter two cases, the beam can be raster-scanned across the entire window to measure how the far-field pattern changes depending on the position of the source. The advantage of raster scanning a focused laser beam is that it is relatively simple to implement and the images will be quite bright. The advantage of using an optically trapped fluorescent emitter is that the source more accurately represents a true point source due to its deeply subwavelength size compared to a focused laser spot, as well as its randomly polarized emission.

Alternatively, the two optical scanning measurements may be employed to generate independent mask estimates that circumvents the use of the TEM for mask estimation. This mask estimation process can be framed as an optimization problem, similar to that in Eq. 2. Typically, this process of estimating an object with resolution better than λ/2 is a very poorly-conditioned optimization problem and highly noise-sensitive (otherwise super-resolution imaging would be quite easy in all microscopy platforms). To make the mask estimation problem more tractable, it is possible to use the fact that the mask is composed of spherical nanoparticles of known and/or substantially constant sizes and material as prior information. As such, one may only need to reconstruct the x-y coordinates of the nanoparticles and not their scattering amplitudes. When the source is a raster-scanned focused laser beam, we can use short wavelengths for higher resolution. If this approach works to reconstruct the mask, it provides an easy and cost-effective method for calibrating each mask without having to use electron microscopy. If the approach works using tightly-focused blue-green light, we will test whether the reconstruction remains accurate for larger spot sizes obtained with longer wavelength light. These multiple wavelengths will be obtained using a supercontinuum laser with tunable filter.

It is believed that the proposed embodiments combine the portability and ultra-wide field of view of lens-free imaging with super-resolution capabilities similar to those of STED, PALM, and STORM microscopy to achieve spatial resolutions higher than λ/10. One of the advantages of the proposed approach is that mask fabrication is easy and inexpensive due to the random positioning of the nanoparticles on the mask as well as the commercial availability of windows with nanoscale thickness at a cost of ˜$10 each. Due to its accessibility, we think the approach could be transformative for researchers who want sub-diffraction limit resolution across ultra-wide fields of view at low cost.

Having the advantage of the above disclosure, a person of ordinary skill in the art will readily appreciate that, in one specific case, the mask layer is intentionally chosen to be spatially separated from the object (along the axis of propagation of light in which imaging of the object is performed) by a non-zero distance. In this case, a non-zero separation is critical to enabling a wide range of samples/objects to be imaged without the samples becoming contaminated by the nanoaperture mask. Such contamination might take the form of chemical interactions with the sample, or geometric deformations of the sample imposed by the mask. At the nanometer length scale of the mask-feature sizes, it is quite challenging to make a heterogeneous surface (e.g., the clear and opaque regions on the mask) truly flat. Forcing a sample to conform to the rough mask surface could undesirably alter the sample. A case in point could be a lipid membrane, such as that on the surface of a biological cell. The rough surface could also affect how cells move in cell migration studies. In applications where we are trying to image nanomaterials, the trenches in the mask could trap the nanomaterials, causing them to cluster and altering the apparent geometric distribution of the nanomaterials. Label-free and contact-free imaging of samples enables those samples to be used multiple times in the same system or in different systems. It is advantageous to image the same sample in multiple systems to validate measurements between systems.

Another advantage of non-zero separation is that when light (evanescent field) diffracts at a feature on the object toward the mask, such light spreads out slightly and so the light from the object feature can interact with a slightly larger area on the mask. This means that the nanostructures on the mask do not have to be as densely placed, which can enable higher overall transmission. It is also expected that the reconstruction process will be easier with the non-zero separation, as the mask can on average interact more strongly with the light from the object.

Yet another anticipated advantage of our nonzero spacing geometry is ease of fabrication of random features of the mask, for example with the use of solutions of nanoparticles with low variance in particle sizes, from which the particles can be easily deposited by pipetting a small volume of nanoparticle solution and letting the solvent evaporate off.

In at least one specific case, the mask is formed of particles of substantially equal sizes, in which case mask estimation is made easier and more accurate. The ability to transform an encoded image of an unknown object (formed at the optical detector) into a resolved image with the use of a programmable processor on knowing the geometry of the mask ahead of time with high resolution, most likely beyond the capabilities of conventional optical microscopy. If the mask geometry were completely unknown, this would be an ill-posed problem, and would be unlikely to work. However, having some prior knowledge about some aspects of the mask geometry (often just called a “prior” in the mathematical field of optimization) facilitates the accurate estimation of the mask geometry. This is because we know that any fuzzy blobs we see in a low resolution optical image of the mask have to correspond to an integer number of nanoparticles of known size.

Common measures of performance in lens-free microscopes include the area of the field of view and smallest resolvable feature of the device. The space-bandwidth product (field of view divided by the smallest resolvable feature) is one way we can quantify this with a single number.

In at least one implementation, a FOV of the proposed imaging methodology exceeds 1 mm², with smallest resolvable features with sizes smaller than <λ/2, in one embodiment of about 200 nm or smaller, and in a related embodiment—of about or even less than one-fifth of the wavelength of light used for imaging.

The term “image” as used herein refers to and is defined as an ordered representation of detector signals corresponding to spatial positions. For example, an image may be an array of values within an electronic memory, or, alternatively, a visual image may be formed on a display device such as a video screen or printer.

References throughout this specification to “one embodiment,” “an embodiment,” “a related embodiment,” or similar language mean that a particular feature, structure, or characteristic described in connection with the referred to “embodiment” is included in at least one embodiment of the present invention. Thus, appearances of the phrases “in one embodiment,” “in an embodiment,” and similar language throughout this specification may, but do not necessarily, all refer to the same embodiment. It is to be understood that no portion of disclosure, taken on its own and in possible connection with a figure, is intended to provide a complete description of all features of the invention.

Within this specification, embodiments have been described in a way that enables a clear and concise specification to bet written, but it is intended and will be appreciated that embodiments may be variously combined or separated without parting from the scope of the invention. In particular, it will be appreciated that all features described herein at applicable to all aspects of the invention.

For the purposes of this disclosure and the appended claims, the use of the terms “substantially”, “approximately”, “about” and similar terms in reference to a descriptor of a value, element, property or characteristic at hand is intended to emphasize that the value, element, property, or characteristic referred to, while not necessarily being exactly as stated, would nevertheless be considered, for practical purposes, as stated by a person of skill in the art. These terms, as applied to a specified characteristic or quality descriptor means “mostly”, “mainly”, “considerably”, “by and large”, “essentially”, “to great or significant extent”, “largely but not necessarily wholly the same” such as to reasonably denote language of approximation and describe the specified characteristic or descriptor so that its scope would be understood by a person of ordinary skill in the art. In one specific case, the terms “approximately”, “substantially”, and “about”, when used in reference to a numerical value, represent a range of plus or minus 20% with respect to the specified value, more preferably plus or minus 10%, even more preferably plus or minus 5%, most preferably plus or minus 2% with respect to the specified value. As a non-limiting example, two values being “substantially equal” to one another implies that the difference between the two values may be within the range of +/−20% of the value itself, preferably within the +/−10% range of the value itself, more preferably within the range of +/−5% of the value itself, and even more preferably within the range of +/−2% or less of the value itself.

The use of these terms in describing a chosen characteristic or concept neither implies nor provides any basis for indefiniteness and for adding a numerical limitation to the specified characteristic or descriptor. As understood by a skilled artisan, the practical deviation of the exact value or characteristic of such value, element, or property from that stated falls and may vary within a numerical range defined by an experimental measurement error that is typical when using a measurement method accepted in the art for such purposes.

While the invention is described through the above-described exemplary embodiments, it will be understood by those of ordinary skill in the art that modifications to, and variations of, the illustrated embodiments may be made without departing from the inventive concepts disclosed herein. For example, and while not necessarily discussed in detail in the above disclosure, a specific embodiment of the optical imaging system of the overall lens-free optical system of the invention may be configured such that the optical detector is disposed to face the mask layer directly (that is, without any tangible component or element therebetween); in a related embodiment, however, the optical spectral filter may be utilized therebetween if certain degree of spectral discrimination is required during the image acquisition. Similarly, there may be optionally employed a non-lens optical component between the laser source of the embodiment of the overall optical system and the optical imaging system such as, for example, an optical reflector.

The term “and/or”, as used in connection with a recitation involving an element A and an element B, covers embodiments having element A alone, element B alone, or elements A and B taken together.

While embodiments of the invention were not necessarily described as including and/or employing a processor (such as programmable electronic circuitry) controlled by instructions stored in a memory, a person of skill appreciates that the operation of the optical system and/or collection and processing of imaging information may be, and preferably is indeed governed by such a processor. The memory may be random access memory (RAM), read-only memory (ROM), flash memory or any other memory, or combination thereof, suitable for storing control software or other instructions and data. Those skilled in the art should also readily appreciate that instructions or programs defining the functions of the present invention may be delivered to a processor in many forms, including, but not limited to, information permanently stored on non-writable storage media (e.g. read-only memory devices within a computer, such as ROM, or devices readable by a computer I/O attachment, such as CD-ROM or DVD disks), information alterably stored on writable storage media (e.g. floppy disks, removable flash memory and hard drives) or information conveyed to a computer through communication media, including wired or wireless computer networks. In addition, while the invention may be embodied in software, the functions necessary to implement the invention may optionally or alternatively be embodied in part or in whole using firmware and/or hardware components, such as combinatorial logic, Application Specific Integrated Circuits (ASICs), Field-Programmable Gate Arrays (FPGAs) or other hardware or some combination of hardware, software and/or firmware components.

Disclosed aspects, or portions of these aspects, may be combined in ways not listed above. Accordingly, the invention should not be viewed as being limited to the disclosed embodiment(s).

What is claimed is:

1. An optical system configured to form an image of an object in light having a wavelength, the optical system comprising an optical imaging system that includes:
a mask layer defined by nano-sized randomly distributed elements and, in operation, positioned in an evanescent near field of the object; and
an optical detector, disposed substantially parallel to the mask layer at a distance beyond and/or outside of the evanescent near field of the object, wherein the optical imaging system does not include a lens.

2. An optical system according to claim 1, wherein one or more of the following conditions is satisfied:
(2A) the mask layer is defined by at least one of
(i) a metasurface containing nano-sized material particles randomly distributed across an optical substrate; and
(ii) a material layer having nano-sized openings formed therethrough and distributed randomly across said material layer; and
(iii) a layer of optical material having non-uniform spatial distribution of a refractive index;
and
(2B) when the mask layer is defined by nano-sized elements that are randomly distributed across the optical substrate, the optical substrate is separated from the optical detector by said mask layer;
and
(2C) wherein, when the mask layer is defined by the nano-sized elements that are randomly distributed across the optical substrate, the optical substrate has a thickness that is smaller than the wavelength;
and
(2D) wherein, when the mask layer is defined by the nano-sized elements that are randomly distributed across the optical substrate, wherein, in operation, the optical substrate carries the object on a surface thereof.

3. An optical system according to claim 1, wherein one or more of the following conditions is satisfied:
(3A) the optical system further comprising one or more of a source of light configured to generate said light and an optical illumination system configured to deliver said light to the mask layer; and
(3B) wherein the optical detector is disposed to directly face the mask layer without an optical component therebetween

4. A method comprising:
using the optical system according to claim 1,
intersecting evanescent optical field, emanating from an object irradiated with an incident optical wavefront containing light at a chosen optical wavelength, with said optical imaging system;
receiving, at the optical detector, said light from said incident optical wavefront that has interacted with the object and with said mask layer and that necessarily contains spatial frequencies representing said evanescent optical field, to form an optical data set representing an encoded image of the object;
and
with programmable electronic circuitry, transforming the encoded image of the object into a resolved image of said object, wherein a smallest spatially-resolved element of the resolved image has an extent that is necessarily smaller than five times said optical wavelength.

5. A method according to claim 4, wherein at least one of the following conditions is satisfied:
(5A) the mask layer is carried and/or supported by an optical substrate and is separated from the object by said optical substrate, and
(5B) a spatial resolution of said resolved image is higher than that defined by an optical diffraction limit.

6. A method comprising:
intersecting evanescent optical field, emanating from an object irradiated with an incident optical wavefront containing light at an optical wavelength, with an optical imaging system that does not contain a lens element and that includes a mask layer that is defined by nano-sized randomly distributed elements and that is positioned in an evanescent near field of the object;
receiving, at an optical detector disposed beyond and/or outside the evanescent near field of the object with respect to the mask layer, the light from said incident optical wavefront that has interacted with the object and with the mask layer and that necessarily contains spatial frequencies representing the evanescent optical field, thereby forming an optical data set representing an encoded image of the object;
with programmable electronic circuitry, transforming the encoded image of the object into a resolved image of the object, wherein a smallest spatially-resolved elements of the resolved image has an extent smaller than five times the optical wavelength.

7. A method according to claim 6, wherein at least one of the following conditions is satisfied:
(7A) the mask layer is carried and/or supported by an optical substrate and is separated from the object by said optical substrate, and
(7B) a spatial resolution of said resolved image is higher than that defined by an optical diffraction limit.

8. A method according to claim 7, wherein said intersecting includes interacting the light from the incident optical wavefront with the mask layer only after said light has interacted with the object.

9. A method according to claim 6, wherein said intersecting includes interacting the light from the incident optical wavefront with the mask layer after said light has interacted with the object.

10. A method according to claim 6, wherein said intersecting includes interacting the light from the incident optical wavefront with the object after said light has interacted with the mask layer.

11. A method according to claim 6, wherein said intersecting evanescent optical field includes intersecting the evanescent optical field with one of:
(11A) a metasurface containing nano-sized material particles randomly distributed across the optical substrate;
(11B) a coating layer having one or more of
(i) nano-sized openings therethrough and distributed randomly across said coating layer, and
(ii) nano-sized elements of a coating material of said coating layer;
and
(11C) a material layer having a non-uniform spatial distribution of a refractive index.

12. A method according to claim 6,
wherein the object includes a fluorophore,
wherein the mask layer is configured as an amplitude mask and/or phase mask, and
further comprising:
exciting the object with a pulse of incident light at a first moment of time, and
exposing the optical detector to light from said pulse of incident light that has interacted with the object and the amplitude mask at a second moment of time delayed from the first moment of time by at least a portion of duration of said pulse.

13. A method according to claim 6, wherein said receiving includes transmitting said light from the incident optical wavefront from the mask layer to the optical detector in absence of an optical spectral filter between the mask layer and the optical detector.

14. A method according to claim 7, wherein said receiving includes receiving, at the optical detector, an optical shadow cast thereon by a combination of said object with said mask layer.

15. A method according to claim 6, wherein one of the following conditions is satisfied:
(15A) wherein said transforming the encoded image includes minimizing a cost-function that at least partially represents differences between first and second encoded images of said object,
wherein the first encoded image represents the object in an initial position and the second encoded image represent the object that has been repositioned from the initial position;
(15B) wherein said transforming includes defining an inverse Fourier transform of a first function representing a convolution of a decoding function with a second function,
wherein the second function represents a spatial distribution, of the light at the optical detector, which distribution has been modified according to a distance separating the mask layer from the optical detector; and
(15C) wherein said transforming includes utilizing a convolutional neural network.

16. A method according to claim 12, wherein one of the following conditions is satisfied:
(16A) wherein said transforming the encoded image includes minimizing a cost-function that at least partially represents differences between first and second encoded images of said object,
wherein the first encoded image represents the object in an initial position and the second encoded image represent the object that has been repositioned from the initial position;
(16B) wherein said transforming includes defining an inverse Fourier transform of a first function representing a convolution of a decoding function with a second function,
wherein the second function represents a spatial distribution, of the light at the optical detector, which distribution has been modified according to a distance separating the mask layer from the optical detector; and
(16C) wherein said transforming includes utilizing a convolutional neural network.

17. A method according to claim 6, further comprising illuminating the object with a substantially planar optical wavefront.

18. A method according to claim 7, wherein said intersecting evanescent optical field includes intersecting the evanescent optical field with one of.
(18A) a metasurface containing nano-sized material particles randomly distributed across the optical substrate;
(18B) a coating layer having one or more of
(i) nano-sized openings therethrough and distributed randomly across said coating layer, and
(ii) nano-sized elements of a coating material of said coating layer; and
(18C) a material layer having a non-uniform spatial distribution of a refractive index.

19. An article of manufacture comprising a portion of the optical system according to claim 1 or the optical system according to claim 1.

20. An article of manufacture comprising an optical substrate having a thickness value smaller than a depth of evanescent optical field produced by an object irradiated with light a predefined wavelength, and
a mask layer defined by nano-sized elements randomly distributed on a surface of the substrate.

21. A method according to claim 5, wherein said intersecting includes interacting the light from the incident optical wavefront with the mask layer only after said light has interacted with the object.

22. A method according to claim 21, wherein said intersecting includes interacting the light from the incident optical wavefront with the mask layer after said light has interacted with the object.

23. A method according to claim 4, wherein said intersecting includes interacting the light from the incident optical wavefront with the object after said light has interacted with the mask layer.

24. A method according to claim 4, wherein said intersecting evanescent optical field includes intersecting the evanescent optical field with one of:
(24A) a metasurface containing nano-sized material particles randomly distributed across the optical substrate;
(24B) a coating layer having one or more of
(i) nano-sized openings therethrough and distributed randomly across said coating layer, and
(ii) nano-sized elements of a coating material of said coating layer;
and
(24C) a material layer having a non-uniform spatial distribution of a refractive index.

25. A method according to claim 4,
wherein the object includes a fluorophore,
wherein the mask layer is configured as an amplitude mask and/or phase mask, and
further comprising:
exciting the object with a pulse of incident light at a first moment of time, and
exposing the optical detector to light from said pulse of incident light that has interacted with the object and the amplitude mask at a second moment of time delayed from the first moment of time by at least a portion of duration of said pulse.
